(19) United States
(12) Patent Application Publication
(10) Pub. No.: US 2026/0218075 A1
(43) Pub. Date: Jul. 30, 2026

(54) MOTOR FUEL MIXED TANKING SCENARIOS

(71) Applicant: Keuken & De Koning B.V., Breda (NL)

(72) Inventor: Hans KEUKEN, Wuustwezel (BE)

(21) Appl. No.: 19/151,728

(22) PCT Filed: Jan. 30, 2024
(86) PCT No.: PCT/NL2024/050041

§ 371 Date: Jul. 29, 2025

(30) Foreign Application Priority Data
Jan. 30, 2023 (NL) 2034053

(51) Int. Cl. C10L 1/182; B67D 7/04

(52) U.S. Cl. CPC C10L 1/1824; B67D 7/0498; C10L 2200/0254; C10L 2200/0423; C10L 2270/023; C10L 2290/24

(57) ABSTRACT

The invention relates to a method to avoid phase separation in a mixed tanking scenario between a hydrous ethanol containing fuel and a further gasoline fuel,
wherein the hydrous ethanol fuel comprises 1-95 weight % ethanol and 1-10 weight % water based on the weight of the ethanol; and
wherein a co-solvent is added to promote the water tolerance;
wherein the method comprises mixing of the hydrous ethanol containing fuel and the further gasoline fuel in a motorized means of transportation, fuel transportation infrastructure, a fuel storage infrastructure, a fuel distribution infrastructure or related equipment.
whereby a mixed fuel is obtained comprising the co-solvent, the hydrous ethanol containing fuel and the further gasoline fuel.

This invention relates to motor fuel mixed tanking scenarios and in particular to co-tank hydrous ethanol containing gasoline fuel with other commercial gasoline fuels (market fuels), or sequentially tank hydrous ethanol containing gasoline fuel after the other commercial gasoline fuel is deplete in the tanks and transportation facilities, and especially tank other commercial gasoline fuel, when hydrous ethanol containing gasoline fuel is mostly consumed.

### BACKGROUND OF THE INVENTION

It is widely known that gasoline and water do not mix. When water is added to gasoline, a separate liquid phase (water phase) will form which contains mainly the water and a very small amount of gasoline. The other phase (gasoline phase) contains a very small amount of water. The water phase has physical properties that are totally different from the gasoline phase, in terms of e.g. density, interfacial tension etc. As a result, water droplets in the gasoline have a strong tendency to coalesce, which leads to a rapid disengagement of the two liquid phase into a lower water layer and an upper gasoline layer. The presence of a separate water layer is generally known to be harmful to systems for fuel storage and distribution, car fuel tanks, fuel injection systems, motor engines and other related systems. E.g. Aakko and Nylund mentioned in ‘Technical View on Biofuels for Transportation—Focus on Ethanol End-Use Aspects’ (VTT, Research Report Pro3/5100/03 6 May 2004) that the presence of water as a separate phase can cause stalling of engines (p32, final paragraph).

With the environmental requirements and sustainability pressure, ethanol has attracted more attention as gasoline blending component. Gasoline and anhydrous ethanol are miscible in any ratio and the obtained gasoline product is termed as “gasohol”. But when a certain amount of water is present, however, a separate liquid layer will occur. This is especially the case when the ethanol is blended in low percentages. The maximum amount of water that does not cause a separate liquid layer to appear shall be known here as the “water tolerance”. However, when the ratio of gasoline-ethanol water is well adjusted, this mixtures (hydrous ethanol containing gasoline, termed as “HE gasoline” or “HE gasoline fuel”) is bright and clear, without necessary additives to preventing the occurrence of a separate liquid phase.

Suitable compositions of HE gasolines, their blending method and use has been described in WO2006/137725 and WO2009/096788.

Compared to anhydrous ethanol containing gasoline with the same ethanol-gasoline ratio, the HE gasoline fuel can improve mileage, decrease overall emission of CO, CO₂, hydrocarbons, aldehydes, oxy-and nitro-poly-aromatic compounds, and keep internal and external environment of internal combustion engines cleaner.

On another side, market gasoline fuels can contain anhydrous ethanol (a.k.a gasohols) although the total alcohol amount is often limited by the total oxygen content permitted by the applicable fuel standards. According to the maximum percentage of ethanol fuel in the mixture by volume, the ethanol fuel mixtures have “E” numbers. In Europe E5-E10 are already available for regular cars. In America, gasolines up to E15 are on the market. In Brazil more ethanol is added to the gasoline with the gasoline E27 commercially available, for normal cars. For flexible fuel vehicles, E85 and E100 are in use in Europe/America and Brazil respectively. The number following the ‘E’ represents the maximum vol % of ethanol in the fuel; in practice the ethanol content can vary. E.g. an E5 (maximum of 5 vol % ethanol), can contain less than 5 vol % ethanol, e.g. about 2 vol % ethanol. Except E100, other market ethanol gasoline fuels are typically made from anhydrous ethanol. The phrase “anhydrous ethanol” refers to ethanol (almost) free of water. In industrial practice there is specification for the maximum water content of anhydrous ethanol, which is typically 0.1-1 percent weight. “Dehydrated alcohol” is synonym for anhydrous alcohol. Hydrous ethanol contains more water than dehydrated alcohol, typically up to 6.1 wt. %, when to be used in fuels. The ethanol content of hydrous ethanol for use in motor fuels is typically at least 93 wt. % (as stipulated in NEN NTA 8115:2013, e.g. of 1 Dec. 2013).

### SUMMARY OF THE INVENTION

The inventors realized that there is a serious risk that those market gasolines other than HE gasoline, are not completely miscible or compatible with the HE gasoline disclosed in the above cited prior art, especially those market gasolines with a low or no ethanol content, such as an ethanol content of 5 vol % or less, in particular about 3 vol. % or less, more in particular about 2 vol. % or less. Insufficient miscibility or compatibility can cause phase separation. The risk thereof depends not only on the fuels composition but also (changes in) ambient temperature.

The inventors realized that it would be desirable to allow for a smooth switching between tanking, transporting, using or storing those market gasoline fuels other than HE gasoline fuels and HE gasoline fuels in a fuel transportation infrastructure, a fuel storage infrastructure, a fuel distribution structure (e.g. a petrol station) or a motorized means of transportation, in particular a vehicle, such as a car, having a combustion engine. The scenario of switching between HE gasoline fuels and other gasoline fuels is also referred to herein as a mixed tanking scenario, a mixed-filling scenario or a mixed-filling-up scenario. This scenario would increase flexibility in choice of gasoline fuel to be tanked (i.e. introduced in a fuel tank), stored, used or passed in an infrastructure or in a motorized means of transportation.

The inventors further found that this is possible by introducing a specific extra measure to increase the water tolerance of market gasoline fuels (free of hydrous ethanol) without anhydrous ethanol or with anhydrous ethanol.

Accordingly, the invention relates to a method to avoid phase separation in a mixed tanking scenario between a hydrous ethanol containing fuel and a further gasoline fuel,
wherein the hydrous ethanol fuel comprises 1-95 weight % ethanol and 1-10 weight % water based on the weight of the ethanol; and
wherein a co-solvent is added to promote the water tolerance; wherein the method comprises mixing of the hydrous ethanol containing fuel and the further gasoline fuel in (a fuel tank of) a motorized means of transportation, a fuel transportation infrastructure, a fuel storage infrastructure, a fuel distribution infrastructure or a related equipment.
whereby a mixed fuel is obtained comprising the co-solvent, the hydrous ethanol containing fuel and the further gasoline fuel. Typically,
   the co-solvent is added to the further gasoline fuel prior to mixing the further gasoline fuel with the hydrous ethanol fuel;
   or the co-solvent is added to the hydrous ethanol containing fuel prior to mixing it with the further gasoline fuel;
   or the co-solvent is added directly to a fuel tank.

Further, the invention relates to method of operating a motorized means of transportation having a combustion engine, in particular a vehicle (such as a car) or of operating a fuel infrastructure wherein at least two types of fuel are subsequently introduced (tanked) in a fuel tank of the motorized means of transportation or in the fuel infrastructure, at least a first fuel being a hydrous ethanol containing fuel and a least a second fuel being a further gasoline fuel, wherein the hydrous ethanol fuel comprises 1-95 weight % ethanol and 1-10 weight % water based on the weight of the ethanol, and wherein a co-solvent is blended with the first fuel, the second fuel or added separately from the first and the second fuel to the fuel tank.

As a result of the subsequent, e.g. alternating, introduction of said first and second fuel and the co-solvent a mixed fuel composed of a hydrous ethanol containing fuel, a further gasoline fuel and a co-solvent is formed in the fuel tank.

The invention further relates to the use (the use comprising combustion) of a mixed fuel, composed of a hydrous ethanol containing fuel, a further gasoline fuel and a co-solvent, in particular such mixed fuel obtained in a method according to the invention, directly in a motor (a combustion engine) without further processing or treatment of the mixed fuel. In particular such use is advantageous using a car comprising a combustion engine, wherein the fuel is combusted.

The mixed fuel obtained in a method according to the invention or used in accordance with the invention is typically at least substantially in a single phase (at least at ambient temperature). Said mixed fuel thereby typically meets a motor fuel specification, such as a clear and bright specification. The mixed fuel typically meets a standard (such as a clear and bright specification), applicable in the Netherlands, the European Union or a standard of another jurisdiction, as applicable on the filing date of the present disclosure. Advantageously, the invention provide a mixed fuel meeting at least NEN-EN 228:2013, e.g. as published 1 Apr. 2013.

Ambient temperature means at least the temperature at which the method or use is carried out, typically a temperature of the outdoor environment, in particular a temperature at which the method or use is carried out that is common for the season and the geographical region wherein the method or use is carried out.

This invention allows the use of hydrous ethanol containing gasoline fuel without physically modifying parts of the infrastructure or transportation means that is in contact with the fuel, e.g. without modifying parts of the motor engines, fuel distribution system inside the transportation means, fuel filling system or fuel transport infrastructures. This invention makes the hydrous ethanol containing gasoline fuel compatible with further market gasoline fuels (free of hydrous ethanol) without anhydrous ethanol or with anhydrous ethanol. It is in particular, an advantage of the invention that it improves compatibility (such as improved water tolerance) also with a further gasoline having a relatively low maximum ethanol content, such as an E1, E2, E5, E10 or E15 gasoline fuel.

Since the production of hydrous ethanol requires less energy than production of anhydrous ethanol, the production of hydrous ethanol containing gasoline is considerably cheaper than the production of anhydrous ethanol containing gasoline. Furthermore, a higher water content in hydrous ethanol containing gasoline works as a corrosion inhibitor for the commonly used aluminum alloys in the fuel line of vehicles.

### BRIEF DESCRIPTION OF THE DRAWING

FIG. 1 shows a ternary liquid-liquid phase diagram of the system water (1)—ethanol (2)—gasoline (3) at 20° C.

### DETAILED DESCRIPTION OF THE INVENTION

It is an object of the present invention to tackle the risk of insufficient compatibility between a hydrous ethanol fuel and another fuel, which is a (market available) gasoline fuel.

The object of this invention is in particular to provide a method, which reduces the risk, or even avoids the risk, of phase separation in mixed tanking scenario's between a market available gasoline fuel other than a hydrous ethanol containing gasoline fuel and a hydrous ethanol containing gasoline fuel.

Also it is an object to use the present invention at a fuel distribution terminal, or more generally in vehicle combustion engines, in particular car combustion engines.

An object of the invention is achieved by a method or use according to the invention as described in the present description, and in particular by a method according to the claims.

Suitable compositions of HE gasoline fuels, their blending method and use has been described in WO2006/137725 and WO2009/096788. In addition to hydrous ethanol, HE gasoline fuels contain a gasoline fraction, which can be a conventional gasoline, typically a mixture of hydrocarbons boiling in the approximate range of 40° C. to 200° C. that can be used as fuel for internal combustion engines. The hydrous ethanol fuel can contain one or more additives suitable for use in known gasoline fuels. Gasoline fuels may contain substances of various nature, which are added in relatively small amounts, to serve a particular purpose, e.g. MTBE or ETBE to increase the octane number. The HE gasoline fuel has an ethanol content of 1 to 95 wt. % based on the total motor fuel and contains 1 to 10 wt. % of water based on the weight of the ethanol. In an advantageous embodiment, the HE gasoline fuel has an ethanol content of at least 5 wt. % of water based on the weight of the ethanol or at least 10 wt. % of water based on the weight of the ethanol. In particular, good market results have been achieved with a HE gasoline fuel, containing an amount of hydrous ethanol of at least 15 vol. % according to the hydrous ethanol specification NTA 8115 update 2013 (https://www.nen.nl/nta-8115-2013-en-185430). Suitable ratios of ethanol, water and gasoline can be based on a liquid-liquid phase diagram of the system water (1)—ethanol (2)—gasoline (3), e.g. as described in WO2006/137725 and WO2009/096788. The contents of WO2006/137725 and WO2009/096788, in particular with respect to definitions of terms and the composition of the HE gasoline fuel (unless specified otherwise herein) is incorporated herein by reference.

The further gasoline fuel is different from the HE gasoline fuel. The further gasoline fuel is typically commercially available gasoline fuel other than a hydrous ethanol containing fuel. The further gasoline fuel can be free of ethanol or be a gasoline fuel containing ethanol (typically anhydrous ethanol). The invention is in particular advantageous to address a compatibility problem with a further gasoline fuel that is free of ethanol or contains a relatively low amount of ethanol. Gasolines labelled as E1, E2, E3, E4 and E5, E10, E15 or E20 do not necessarily contain the amount of ethanol indicated by the label, because the label indicates the maximum according to the fuel specifications. In an advantageous embodiment, the further gasoline fuel has an ethanol content of 0-5 vol % ethanol, more preferably up to about 4 vol % ethanol, more preferably up to about 3 vol. %. If present, the ethanol content of the further gasoline can be at least 0.01 vol %, in particular at least 0.1 vol %, more in particular at least 0.5 vol %, more in particular at least 1.0 vol %. In an advantageous embodiment, the hydrous ethanol fuel has an ethanol content that is higher than the ethanol content of the further gasoline fuel. The further gasoline fuel can contain one or more additives known for use in gasoline fuels.

To tackle the potential compatibility problem, an effective amount of co-solvent is introduced to improve the water tolerance of the related fuels. The co-solvent advantageously comprises one or more components selected from methanol (MeOH), ethanol (EtOH), isopropyl alcohol (IPA), n-butanol (BuOH), t-butanol (TBA), isobutanol (i-BuOH), tertiary amyl methyl ether (TAME), tertiary hexyl methyl ether (THEME), Methyl-tert-butylether (MTBE), ethyl tertiary butyl ether (ETBE), tertiary amyl ethyl ether (TAEE) and diisopropyl ether (DIPE). Typically, the co-solvent comprises at least 85 wt. % of said component or said components (in total), in particular between 90 wt. % and 100 wt. %. Preferably, the co-solvent is or comprises one or more components selected from ethanol (EtOH), isopropyl alcohol (IPA), n-butanol (BuOH), and t-butanol (TBA), including combinations thereof. If ethanol is used as a co-solvent, it preferably is anhydrous ethanol.

The co-solvent can be included in various ways. The co-solvent can be added to the further gasoline fuel prior to mixing the further gasoline fuel with the HE gasoline fuel; the co-solvent can be added to the HE gasoline fuel prior to mixing it with the further gasoline fuel; the co-solvent can be added directly to a fuel tank, in particular of a motorized means of transportation, such as a vehicle.

A direct approach is first to blend the co-solvent with the further (market) gasoline fuel, and then the obtained blend of further (market) gasoline fuel and co-solvent is blended further with the HE gasoline fuel. A further direct approach is first to blend the co-solvent with the HE gasoline fuel, and then the obtained blend of HE gasoline fuel and co-solvent is blended further with the further (market) gasoline fuel.

In a specific embodiment, a fuel tank of the motorized means of transportation-preferably of a car-the tank containing further gasoline fuel is refueled, which refueling comprises subsequently adding the co-solvent and the hydrous ethanol fuel.

In a further specific embodiment, a fuel tank of the motorized means of transportation,—preferably of a car—the tank containing hydrous ethanol fuel is refueled, which refueling comprises subsequently adding the co-solvent and the further gasoline fuel.

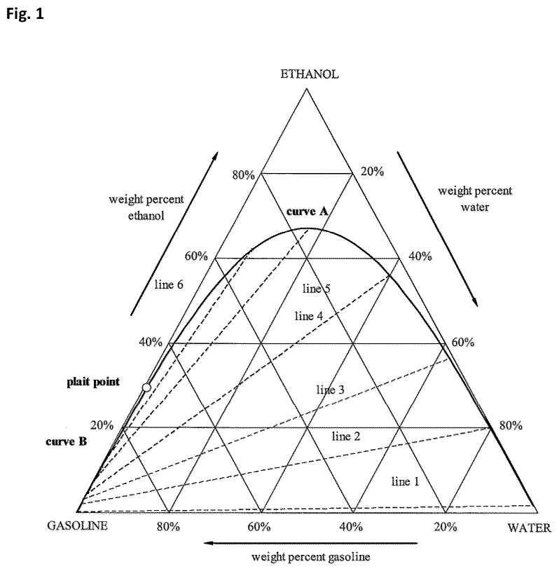

The used amount of co-solvent depends on the fuels'compositions and ambient temperature. For a mixed tanking scenario, the first gasoline fuel is generally already present in the infrastructure or vehicle, such as in a storage tank thereof, yet at a low level (depleted) due to the usage, and then the second gasoline fuel is added. If the first fuel is the further (market) gasoline and the second fuel is HE gasoline fuel with a composition far from the phase separation boundary (curve A, FIG. 1), little or even no co-solvent is required to keep the fuel homogeneous after mixed filling of a fuel tank. If the first fuel is HE gasoline fuel and the second fuel is further (market) gasoline fuel with little or no anhydrous ethanol, which are represented by the region near the gasoline corner of the phase diagram (FIG. 1), practically all compositions fall in the two-liquid region, and the second liquid phase is rich in water and consequently is characterized as “water phase”. In this case more co-solvent is required to promote the miscibility of the mixture after mixed filling of a fuel tank.

To ease the mixed filling of a fuel tank without phase separation issues, it is advised to add maximum amount co-solvent to improve water tolerance ability. It is especially the case because ambient water and moisture can penetrate into the fuel along the logistic chain.

For the purpose of clarity and a concise description, features are described herein as part of the same or separate embodiments, however, it will be appreciated that the scope of the invention may include embodiments having combinations of all or some of the features described.

As used herein, the singular forms “a”, “an” and “the” are intended to include the plural forms as well. The term “or” includes any and all combinations of one or more of the associated listed items, unless the context clearly indicates otherwise (e.g. if an “either . . . or” construction is used). It will be understood that the terms “comprises” and “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise.

The present invention, thus generally described, will be understood more readily by reference to the following examples, which are provided by way of illustration and should not be construed as limiting any aspect of the present invention.

### EXAMPLE 1

500 parts by volume of commercial gasoline SuperPlus (no ethanol in most of the cases) was blended with 20 parts by volume of HE15. The obtained fuel was turbid (not clear and bright), as assessed visually.

500 parts by volume of commercial gasoline SuperPlus (no ethanol in most of the cases) was blended with 25 parts by volume of anhydrous ethanol as co-solvent. The resulted mixture was further blended in a mixed scenario with the remaining 20 parts by volume of HE15 in the tank. The obtained fuel was clear and bright, as assessed visually.

### EXAMPLE 2

500 parts by volume of commercial gasoline SuperPlus was blended with 50 parts by volume of HE20 gasoline. The obtained fuel was turbid (not clear and bright), as assessed visually.

500 parts by volume of commercial gasoline SuperPlus was blended with 25 parts by volume of t-butanol as co-solvent. The resulted mixture was further blended in a mixed tanking scenario with the remaining 50 parts by volume of HE20 gasoline in the tank. The obtained fuel was clear and bright, as assessed visually.

### EXAMPLE 3

A consumer with a car running on HE gasoline tanked after the fuel level was low. The rest of the car tank was further filled up with other commercial gasoline(s). The obtained fuel was turbid, as assessed visually.

A consumer with a car running on HE gasoline filled up the tank after the fuel level was low. 1 liter of E85 (a blend of 15 vol % hydrocarbon/gasoline and 85 vol % anhydrous ethanol) was first fueled to the tank. The rest of the car tank was filled up with other commercial gasoline(s). The obtained fuel was clear and bright, as assessed visually.

1. A method to avoid phase separation in a mixed tanking scenario between a hydrous ethanol containing fuel and a further gasoline fuel,
wherein the hydrous ethanol fuel comprises 1-95 weight % ethanol and 1-10 weight % water based on the weight of the ethanol;
wherein a co-solvent is added to promote the water tolerance;
wherein the method comprises mixing of the hydrous ethanol containing fuel and the further gasoline fuel in a motorized means of transportation, a fuel transportation infrastructure, a fuel storage infrastructure, a fuel distribution infrastructure or related equipment;
wherein
the co-solvent is added to the further gasoline fuel prior to mixing the further gasoline fuel with the hydrous ethanol fuel;
or the co-solvent is added to the hydrous ethanol containing fuel prior to mixing it with the further gasoline fuel;
or the co-solvent is added directly to a fuel tank;
whereby a mixed fuel is obtained comprising the co-solvent, the hydrous ethanol containing fuel and the further gasoline fuel.

2. A method of operating a motorized means of transportation having a combustion engine or of operating a fuel infrastructure, wherein at least two types of fuel are subsequently introduced in a fuel tank of the motorized means of transportation or in a fuel tank of the fuel infrastructure, at least a first fuel being a hydrous ethanol containing fuel and a least a second fuel being a further gasoline fuel, wherein the hydrous ethanol fuel comprises 1-95 weight % ethanol and 1-10 weight % water based on the weight of the ethanol, and wherein a co-solvent is blended with the first fuel or with the second fuel or added separately from the first and the second fuel into the fuel tank.

3. The method according to claim 1, wherein the method comprises operating the motorized means of transportation, wherein the motorized means of transportation is a vehicle, and the method comprises a mixed tanking scenario, comprising switching between refueling the vehicle with the hydrous ethanol containing fuel and refueling with the further gasoline fuel.

4. The method according to claim 1, wherein the co-solvent is selected from the group consisting of methanol (MeOH), ethanol (EtOH), isopropyl alcohol (IPA), n-butanol (BuOH), iso-butanol (IBA), t-butanol (TBA), tertiary amyl methyl ether (TAME), tertiary hexyl methyl ether (THEME), Methyl-tert-butylether (MTBE), ethyl tertiary butyl ether (ETBE), tertiary amyl ethyl ether (TAEE) and diisopropyl ether (DIPE), including combinations thereof.

5. The method according to claim 4, wherein the co-solvent is or comprises one or more components selected from ethanol (EtOH), isopropyl alcohol (IPA), n-butanol (BuOH) and t-butanol (TBA).

6. The method according to claim 5, wherein ethanol is used as a co-solvent, which ethanol is anhydrous ethanol.

7. The method according to claim 1, wherein the co-solvent is or has been added to the further gasoline.

8. The method according to claim 1, wherein the co-solvent is or has been added to the hydrous ethanol containing fuel, wherein the hydrous ethanol containing fuel is a hydrous ethanol containing gasoline.

9. The method according to claim 1, wherein the fuel tank of the motorized means of transportation, containing further gasoline fuel, is refueled, which refueling comprises subsequently adding the co-solvent and the hydrous ethanol fuel.

10. The method according to any claim 1, wherein the fuel tank of the motorized means of transportation, the fuel tank containing hydrous ethanol fuel is refueled, which refueling comprises subsequently adding the co-solvent and the further gasoline fuel.

11. The method according to claim 1, wherein the further gasoline fuel contains less than 5 vol. % ethanol, based on total volume.

12. The method according to claim 1, wherein the further gasoline fuel is selected from the group consisting of E1, E2, E3, E4, E5, E10, E15 and E20 gasoline fuels.

13. The method according to claim 1, wherein the hydrous ethanol fuel has a higher ethanol content than the further gasoline fuel.

14. The method according to claim 1, wherein the obtained mixed fuel is used directly in a combustion engine without further processing or treatment.

15. Method according to claim 14, wherein the combustion engine is a combustion engine of a car.

16. The method of claim 2, wherein the method is a method of operating a motorized means of transportation having a combustion engine, wherein the motorized means of transportation is a car, wherein the method comprises a mixed tanking scenario, comprising switching between refueling the vehicle with the hydrous ethanol containing fuel and refueling with the further gasoline fuel.

17. The method according to claim 2, wherein the co-solvent is or has been added to the further gasoline.

18. The method according to claim 2, wherein the co-solvent is or has been added to the hydrous ethanol containing fuel, wherein said hydrous ethanol containing fuel is a hydrous ethanol containing gasoline.

19. The method according to claim 2, wherein a fuel tank of the motorized means of transportation, the fuel tank containing further gasoline fuel, is refueled, which refueling comprises subsequently adding the co-solvent and the hydrous ethanol fuel.

20. The method according to claim 2, wherein a fuel tank of the motorized means of transportation, the fuel tank containing hydrous ethanol fuel, is refueled, which refueling comprises subsequently adding the co-solvent and the further gasoline fuel.
